(19) United States
(12) Patent Application Publication
(10) Pub. No.: US 2026/0066546 A1
(43) Pub. Date: Mar. 5, 2026

(54) COMPACT NOISE IMMUNE ANTENNA FOR WIRELESS DEVICE

(71) Applicants: Reza Yazdani, Rolla, MO (US); Chulsoon Hwang, Rolla, MO (US)

(72) Inventors: Reza Yazdani, Rolla, MO (US); Chulsoon Hwang, Rolla, MO (US)

(73) Assignee: The Curators of the University of Missouri, Columbia, MO (US)

(21) Appl. No.: 18/816,614

(22) Filed: Aug. 27, 2024

(51) Int. Cl. H01Q 13/10; H01Q 1/48

(52) U.S. Cl. CPC H01Q 13/106; H01Q 13/16

(57) ABSTRACT

A slot antenna configuration is described for a wireless device. The wireless device includes a plurality of electronic components for sending and receiving signals to and from other devices. The antenna configuration is specifically designed to minimize radio-frequency desensitization resulting from electromagnetic interference generated by the plurality of electronic components within the wireless device. The antenna configuration has a primary slot comprising a plurality of linear slot sections, a ground plane, and a conductive metal trace. The antenna slot is configured to send and receive signals in a selected frequency range common among wireless devices. The antenna configuration significantly increases sensitivity to signals while maintaining performance in other areas.

### FIELD

The present disclosure relates generally to wireless devices and, more particularly, to antennas configured to minimize radio-frequency desensitization.

### BACKGROUND

Wireless features are ubiquitous in modern technology. Daily tasks such as calling, texting, navigating, and accessing the internet all depend on the reliable performance of wireless technology. Hence, any improvement in the performance of wireless technology offers broad benefits.

Antennas are the basis of wireless technology. Despite their countless applications and complex designs, many antennas are simple with respect to mechanical characteristics, and are therefore capable of being produced in large quantities. This lowers the per-unit cost of each antenna, which has propelled research and development of antenna technology to a significant degree.

While other communication methods offer specific advantages over wireless communication, they do so only in select circumstances and often at great cost. Fiber optic cables, for example, are superior to wireless communication with respect to signal attenuation and bandwidth; this means that more information may be reliably transferred (per unit time) via fiber optic cabling than via wireless communication. However, wired connections are oftentimes frustrating to manage and difficult to modify. If fiber optic cables are to be installed in a building, great effort is required to route the cabling through existing walls. For long distance cables, the process of laying/erecting transmission lines can cost millions of dollars. This is not true of wireless communication.

Despite these benefits, there are distinct areas of need. One such need is the reliable reception of signal. For residential use, there is typically a single router per household, meaning that one device must transmit data to and from multiple devices across the residence. This often entails communicating through multiple walls and floors. WiFi and Bluetooth signals are transmitted at frequencies up to several gigahertzes, resulting in greater signal attenuation and decreased capacity to penetrate or bypass obstacles when compared to signals of lower frequency (i.e., radio-frequency signals). There has been progress in remedying this issue, however it has focused on increased signal amplification on part of the router. Signal amplification of the sort necessary to improve connectivity has resulted not only from an increase in the power delivered to the transmitting antenna, but from an improved ability to focus the signal via antenna design. While these innovations are no doubt significant, they do not address issues local to a wireless device. Power delivery and signal focusing are variables to consider when designing a compact antenna for wireless devices, but there are limits to their applicability. With respect to power delivery, most wireless devices run on power stored in a battery, and must therefore balance use-time with performance. Modern cell phones have a charge capacity within the 2-4 amp-hour range; most of this power is allocated to local processes. Other wireless devices such as laptop computers store more charge, but are specifically designed to perform energy-intensive computational tasks. This leaves little ability to allocate precious energy toward the production of a stronger signal. With respect to signal focusing, antennas must be extremely small to fit within a mobile device housing, and must not impair the function of nearby electronic components. Consequently, improvements in antenna design for mobile devices cannot entail any significant increase in size.

Additionally, a good connection can be difficult to achieve even if no obstacles block the connection path, as signal strength decreases with distance. Open concept offices, for example, do not provide many physical obstructions to signal propagation, yet they often employ several routers on a single floor. This is because the vast area of large offices makes it difficult for a device on one end of a floor to reach a router on the other end of the floor. Distance is of even greater concern for institutions such as colleges or company headquarters which wish to provide full-coverage Wi-Fi for an entire campus; even a vast array of routers has difficulty providing reliable connectivity to every area of a large campus.

The most promising opportunities for progress with respect to signal reception entail alterations to the mobile antenna, specifically in the pursuit of increased sensitivity—this means less noise. Within the context of mobile devices, the majority of noise results from near-field interference originating from internal electronic components on the integrated circuit board and elsewhere. This specific form of interference is often referred to as radio-frequency (RF) desensitization, as it decreases the antenna's ability to register RF signals. Present technology addresses RF desensitization by shielding electronic components with insulating material in order to reduce the effects of near-field interference on the antenna's ability to receive signals. While this is superior to the alternative of unprotected electronics, a reduction in noise significant enough to significantly improve antenna sensitivity would require excessive shielding, which would drive up production costs and increase the size and weight of a device. Attempts to remedy RF desensitization via shielding have hitherto proved insufficient.

In view of the foregoing, there is a need for a compact antenna for use in wireless devices which addresses the ongoing need for an improved signal-to-noise ratio in small wireless devices.

In view of the foregoing, there is a need for a compact antenna for use in wireless devices which facilitates long range reception of RF signals.

### SUMMARY

In an aspect, a slot antenna for use in a wireless device comprises a conductive ground plane and a metal trace on top of the ground plane and insulated from it. The conductive ground plane defines a slot having a plurality of linear slot sections. The linear slot sections comprise first, second, third, fourth, and fifth slot sections formed in the ground plane. The first slot section extends outwardly from an interior point on the ground plane. The second slot section is perpendicular to the first slot section, and a proximal end of the second slot section is connected to a distal end of the first slot section. The third slot section is parallel to the first slot section and perpendicular to the second slot section. A proximal end of the third slot section is connected to a distal end of the second slot section. The fourth slot section is parallel to the second slot section and perpendicular to the third slot section. A proximal end of the fourth slot section is connected to a distal end of the third slot section. The fifth slot section is parallel to the third slot section and perpendicular to the fourth slot section. A proximal end of the fifth slot section is connected to a distal end of the fourth slot section. The metal trace extends horizontally across at least a portion of the slot and has a feed-point end and a termination end. The metal trace is configured to supply excitation current to the slot antenna via the feed-point.

In another aspect, a slot antenna comprises a conductive ground plane defining a slot and a metal trace on top of the ground plane and insulated from it. The slot has an inner perimeter and an outer perimeter, each having a substantially rectangular geometry. The slot also has an inner region of the ground plane interior to the inner perimeter of the slot and an outer region of the ground plane exterior to the outer perimeter of the slot. A bridge connects the inner region to the outer region and has a first and second edge. The first and second edges are spaced apart a distance defining a bridge width. The metal trace extends horizontally across at least a portion of the slot and has a feed-point end and a termination end. The metal trace is configured to supply excitation current to the slot antenna via the feed-point.

Other aspects will be in part apparent and in part pointed out hereinafter.

### BRIEF DESCRIPTION OF THE DRAWINGS

FIG. 1 diagrammatically shows a compact noise-immune antenna according to an embodiment.

FIG. 2A is top plan view of a slot of the antenna of FIG. 1.

FIG. 2B is top plan view of a metal trace of the antenna of FIG. 1.

FIG. 3 is an elevation of the antenna of FIG. 1.

FIG. 4 shows the antenna of FIG. 1 interfacing with a wireless device according to an embodiment.

FIGS. 5A and 5B show locations of loop antennas for simulating IC noise for testing the antenna of FIG. 1 according to an embodiment.

FIG. 6A illustrates an inverted F antenna according to the prior art.

FIG. 6B is a graph illustrating simulated immunity performance at 2.45 gHz for the antenna of FIG. 6A.

FIG. 6C illustrates a patch antenna according to the prior art.

FIG. 6D is a graph illustrating simulated immunity performance at 2.45 gHz for the antenna of FIG. 6C.

FIG. 7A further illustrates a compact noise-immune antenna according to an embodiment.

FIG. 7B is a graph illustrating simulated immunity performance at 2.45 gHz for the antenna of FIG. 7A.

FIG. 8 shows the current rotation of the Inverted-F antenna of 6A.

FIG. 9 shows the current rotation of a compact noise-immune antenna according to an embodiment.

FIG. 10 is a simulation summary of the simulations of FIG. 6B, FIG. 6D, FIG. 7B, FIG. 8, and FIG. 9.

Corresponding reference characters indicate corresponding parts throughout the drawings.

### DETAILED DESCRIPTION

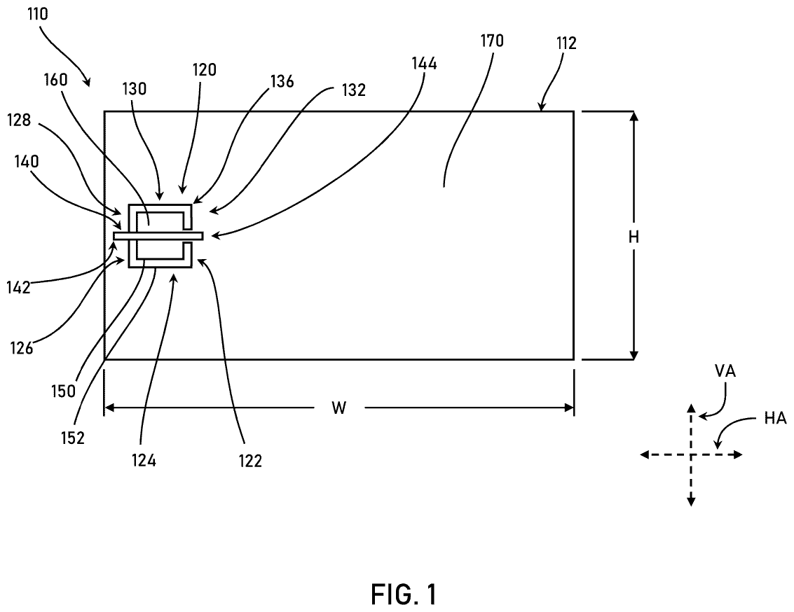

FIG. 1 shows some details of a slot antenna for improved performance with respect to radio-frequency (RF) desensitization.

In an embodiment, the slot antenna includes a ground plane. The ground plane as shown in FIG. 1 is a rectangular element, but it should be understood that the ground plane can be formed as alternative shapes. The ground plane need not be implemented in any particular part of a device which includes the antenna, but it may comprise any conductive part of the device or the device housing. In FIG. 1, the antenna ground plane may be arranged, for example, as a lowest layer of an electronic component of a device, such as a printed circuit board (PCB) or integrated circuit (IC). While the ground plane has a depth, the depth is of little concern with respect to the performance of the antenna, and is instead a matter of material cost and bulkiness. On the other hand, the area of the ground plane does have meaningful implications with respect to the performance of the antenna.

A slot antenna comprising a primary slot, a metal trace, and a ground plane are shown in FIG. 1. The slot is comprised of a series of linear slot sections which are defined by openings in the ground plane on both sides of the plane (hereinafter the linear slot sections may be referred to as linear slots, but it is to be understood that they are sections of the primary slot, not slots unto themselves). The width of the slot is substantially uniform at all points along the slot, with the exception of slot joints where two linear slots join along a shared end.

There are five individual linear slots. Each linear slot has a proximal end and a distal end. The first linear slot begins at a distance from the edge of the ground plane and extends outwardly toward the edge of the ground plane. The proximal end of the first linear slot has a generally rectangular geometry.

The first linear slot's distal end is spaced apart from the proximal end along the length of the slot section. Unlike the proximal end, there are no definite barriers defining the distal end. Rather, it is a region to which the second linear slot is adjoined.

The second linear slot extends laterally across the ground plane, and forms a right angle with the first linear slot. The proximal end of the second linear slot is connected to the distal end of the first linear slot at a slot junction.

The third linear slot connects to the distal end of the second linear slot at its proximate end, forming another slot junction. Like the relationship between the second and first linear slots, the third linear slot forms a right angle with the second linear slot. The third linear slot extends across the ground plane parallel to the first linear slot.

The fourth linear slot adjoins the third linear slot to form yet another slot junction. The proximal and distal ends of the fourth linear slot and third linear slot form the junction, respectively. This slot junction, like the others, forms a right angle. As such, the fourth linear slot extends parallel to the second linear slot toward the first linear slot. It is the same length as the second linear slot.

The fifth and final linear slot adjoins the fourth linear slot to form a final slot junction. The proximal and distal ends of the fifth linear slot and fourth linear slot form the junction, respectively. The slot junction makes a right angle and, as a result, the fifth linear slot extends across the ground plane in the direction of and parallel to the first linear slot. Because the fourth linear slot is equal in length to the second linear slot, the fifth linear slot is positioned in line with the first linear slot. As can be observed in FIG. 1, the first and fifth linear slots occupy a shared axis. However, the fifth linear slot does not extend far enough to connect to the first linear slot.

The resultant shape of these linear slots is a substantially rectangular c-shaped primary slot. The region of ground plane between the distal and proximal ends of the fifth and first linear slot, respectively, form a bridge between the outer and inner ground plane.

A metal trace extends horizontally across the slot. The trace passes over the bridge and spans the entirety of the slot shape, such that both the feed point end and termination end contact the outer ground plane on opposite sides of the slot. Those skilled in the art are familiar with supplying excitation current to the antenna from driving circuitry, such as a transceiver (not shown), via the metal trace. When used for reception, the metal trace conducts current induced in the antenna by incident RF signals to receiving circuitry (not shown), such as a transceiver for filtering, amplification and demodulation. Although in the embodiments described herein the signal feed conductor may be considered a microstrip-type direct feed connector, those ordinarily skilled in the art will appreciate that the signal feed conductor may be a different type of feed.

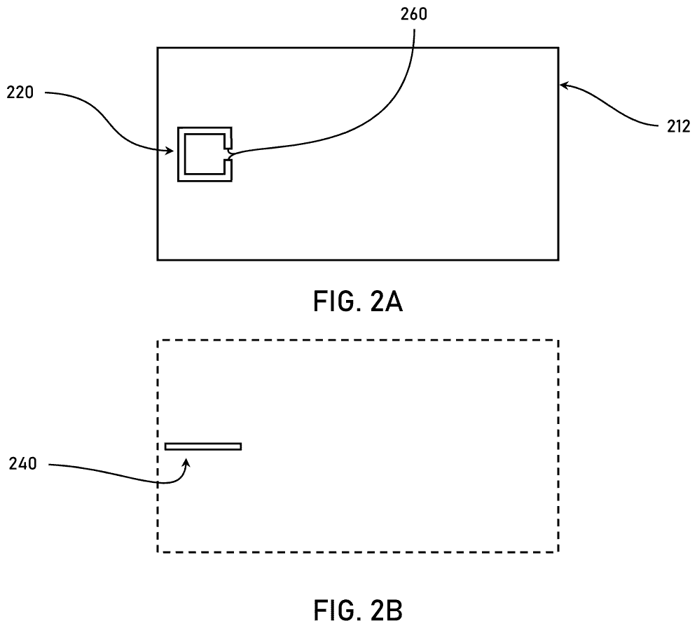

FIG. 2A and FIG. 2B show how the metal trace is at an elevated position with respect to the surface of the ground plane. FIG. 2A shows the slot without the metal trace, and FIG. 2B shows the metal trace without the ground plane. In the present embodiment, the feed point for the metal trace is positioned closer to the center of the ground plane, and the termination end is closer to the edge, however those skilled in the art will understand that the termination end and feed point end may be reversed without impeding the function of the antenna and that the termination is not always necessary.

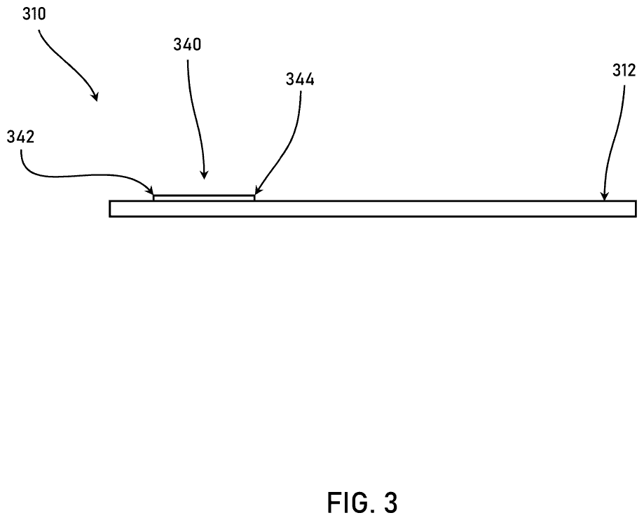

FIG. 3, like FIG. 2A and FIG. 2B, shows the metal trace at an elevated position with respect to the ground plane and the slot. It is to be understood that the depth of the metal trace, within reasonable bounds, does not have great effect on the performance of the antenna.

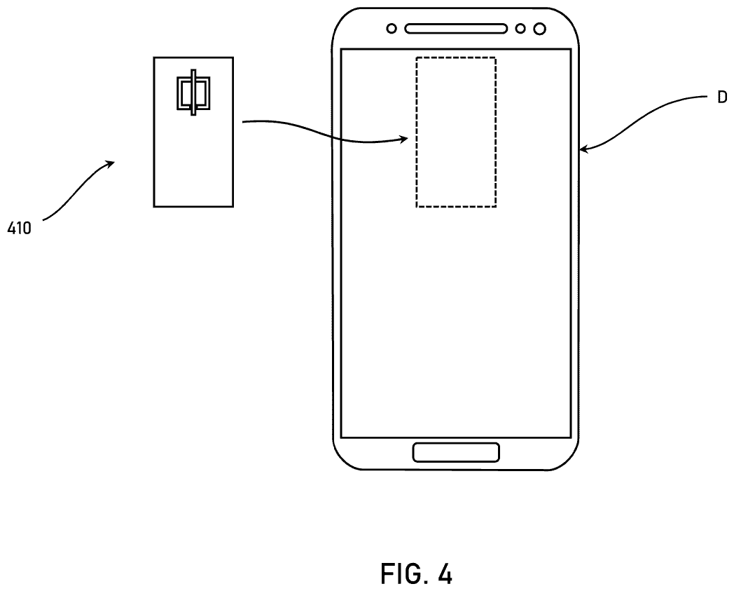

FIG. 4 shows how the antenna can be positioned within a cellular device. A dashed line indicates the position of the antenna within the cellular device. The substantially planar form of the antenna makes it well suited for portable devices with flat configurations such as a laptop or tablet. It will be understood by those skilled in the art that the exact dimensions of the antenna, including the width and height of the ground plane, the width of the slot, and the lengths of the linear slots, may be adjusted to meet desired performance characteristics while maintaining a compact form within the device. While the antenna shown in FIG. 4 is intended for integration with a cell phone, the antenna may be included in a variety of wireless devices.

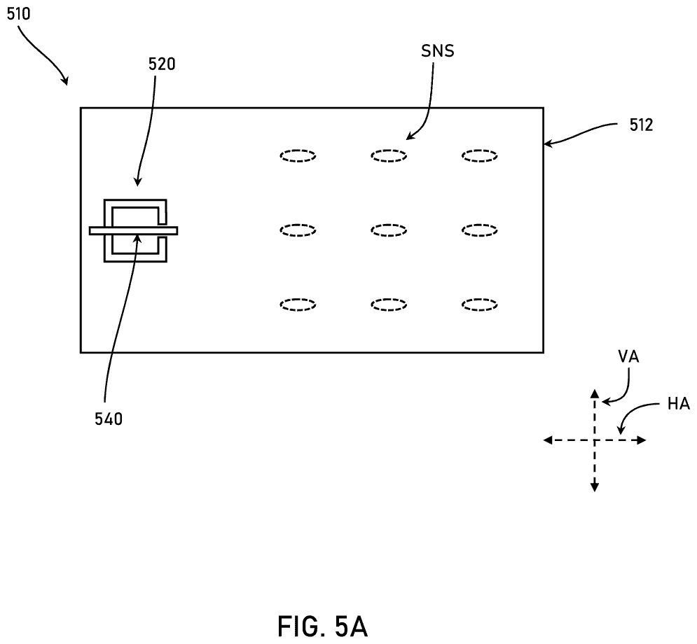

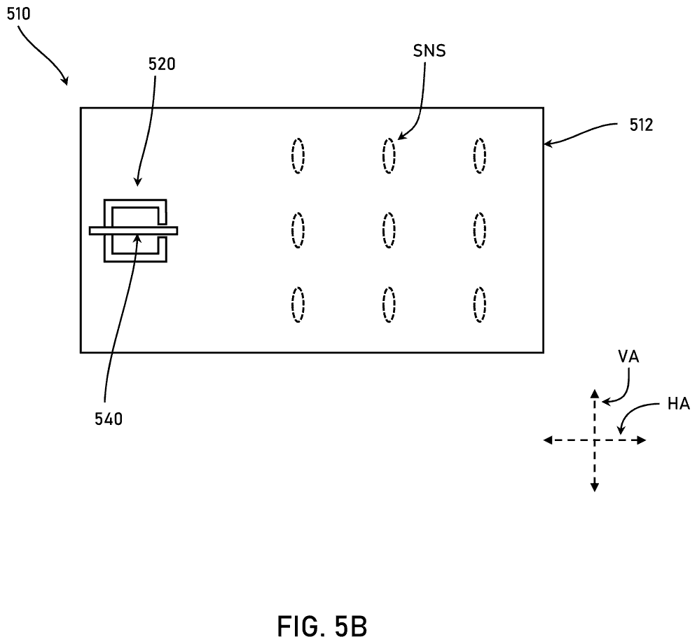

FIG. 5A and FIG. 5B show a top-view diagram of the antenna in conjunction with a number of small loop antennas distributed evenly about the area of the ground plane. This is a visual representation of the setup used in a number of simulations for determining noise-antenna coupling, and the same setup used in later figures to demonstrate the superiority of the antenna when compared to prior art. Loop antennas simulate noise produced by electronics within a wireless device, such as a CPU, memory unit, or resistors. The near-field effects of such components are a source of RF desensitization; as such, a lattice of loop antennas with similar near-field profiles may be used to approximate and measure changes in a device's immunity to RF desensitization.

A small loop antenna can be defined as:

$$\vec{M} = \hat{x} \vert M \vert {e}^{j {θ}_{m}} cos φ + \hat{y} \vert M \vert {e}^{j {θ}_{m}} sin φ$$

where x\hat{ } and y\hat{ } represent the unit vectors aligned with the x-, y-, axis, respectively. |M| and θₘ denote the magnitude and phase of the dipole, respectively. φ is the rotation angle relative to the x-axis. The received voltage at the antenna port can be derived as:

$${U}_{ant} = \frac{{Z}_{L}}{2 {V}^{i}} ( \vec{H} \cdot \vec{M} )$$

where \vec{H} and Vⁱ are the antenna's magnetic field at the magnetic dipole location and the incident input voltage, respectively. Z_{L} is the load impedance of the receiver circuit and can be considered as 50 Ohms. By substituting (1) into (2) we have:

$${U}_{ant} = \frac{{Z}_{L}}{2 {V}^{i}} \vert M \vert {e}^{j {θ}_{m}} ( \vert {H}_{x} \vert {e}^{j {ϕ}_{x}} cos φ + \vert {H}_{y} \vert {e}^{j {ϕ}_{y}} sin φ )$$

where |Hₓ| and Øₓ, |H_{y}| and Ø_{y} are the magnitude and phase of the complex number Hₓ and H_{y}, respectively.

In general, the antenna, in its near field, can have an elliptical magnetic field with an axial ratio (AR) of:

$$AR = \frac{Major\_axis}{Minor\_axis} = \frac{OA}{OB}$$

where the major axis (2×OA) is:

$$OA = \sqrt{\frac{1}{2} [ {\vert {H}_{x} \vert}^{2} + {\vert {H}_{y} \vert}^{2} + \sqrt{{\vert {H}_{x} \vert}^{4} + {\vert {H}_{y} \vert}^{2} + 2 {\vert {H}_{x} \vert}^{2} {\vert {H}_{y} \vert}^{2} cos ( 2 {δ}_{L} )} ]}$$

and the minor axis (2×OB) is:

$$OB = \sqrt{\frac{1}{2} [ {\vert {H}_{x} \vert}^{2} + {\vert {H}_{y} \vert}^{2} - \sqrt{{\vert {H}_{x} \vert}^{4} + {\vert {H}_{y} \vert}^{2} + 2 {\vert {H}_{x} \vert}^{2} {\vert {H}_{y} \vert}^{2} cos ( 2 {δ}_{L} )} ]}$$

### And:

$$τ = - \frac{1}{2} arctan ( \frac{2 \vert {H}_{x} \vert \vert {H}_{y} \vert}{{\vert {H}_{x} \vert}^{2} - {\vert {H}_{y} \vert}^{2}} cos ( {δ}_{L} ) )$$

where δ_{L}=Øₓ−Ø_{y}, and τ is the tilt angle of OA (or OB) with the y-axis (or x-axis). From these we see that coupling to the antenna will be at a minimum when M (the magnetic dipole of the integrated circuit or noisy component) lies along with the OB (minor axis) direction, when (φ=τ). Additionally, the amplitude of the lowest possible coupling voltage to the antenna can be found as:

$$\vert {U}_{ant}^{min} \vert = \frac{{Z}_{L}}{2 {V}^{i}} OB \vert M \vert$$

Notably, the coupling could approach zero when OB=0 or the antenna has AR=∞.

This relationship between the direction of the magnetic dipole of a noisy component and the degree to which it couples with the antenna is critical to the novel performance improvements of the antenna, and underpins the simulations used to quantify the difference in RF desensitization across different antenna configurations. Because coupling is minimal when the magnetic dipole of the noise source is orthogonal to the antenna current flow along the ground plane, performance of an antenna can be dramatically improved by strategically orienting an integrated circuit such that current flow within the circuit runs orthogonal to the current along the ground plane.

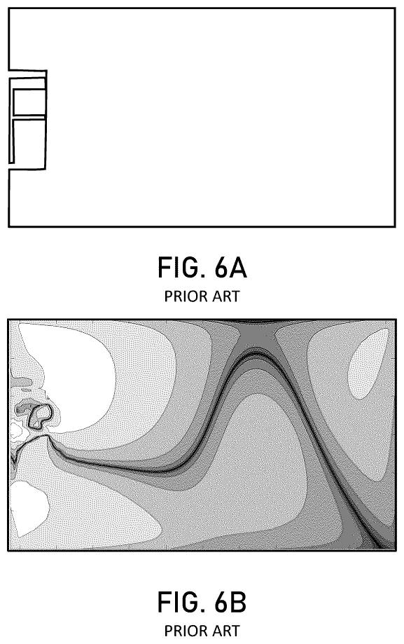

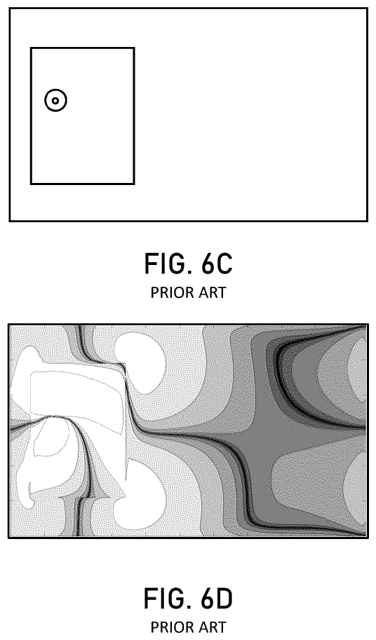

FIG. 6A is a graph of an Inverted-F antenna common among wireless devices in the prior art. The Inverted-F antenna is a popular choice for integration in electronic devices for a number of reasons, but namely its compact design and ease of manufacture. It does not, however, offer significant protection from near-field interference from noise sources local to the device such as a PCB, and consequentially performs quite poorly at receiving weak signals. FIG. 6B is a graph illustrating the results of the computational technique for assessing performance in noise reduction described above when applied to the Inverted-F antenna of FIG. 6A. The differing shades correspond to differences in magnetic coupling with the antenna. Specifically, dark regions indicate relatively low coupling with the antenna (high RF immunity), while light regions indicate relatively high coupling with the antenna (low RF immunity). It will be appreciated by anyone of ordinary skill in the art that the pattern represented in FIG. 6B does not offer great performance with respect to RF desensitization. An undesirably large portion of the ground plane experiences relatively high levels of coupling with the antenna, especially toward the part of the ground plane having the antenna, leaving little room for circuit components. Additionally, the pattern is highly varied and largely asymmetrical, making it even more difficult to intentionally shelter noisy components within the dark regions.

FIG. 6C is a graph of a patch antenna common among wireless devices in the prior art. The patch antenna is a popular choice for integration in electronic devices for reasons similar to those of the Inverted-F antenna: compact design and ease of manufacture. It does not, however, offer significant protection from near-field interference from noise sources local to the device such as a PCB, and consequentially performs quite poorly at receiving weak signals. FIG. 6D is a graph illustrating the results of the computational technique for assessing performance in noise reduction described above when applied to the patch antenna of FIG. 6C. The differing shades correspond to differences in magnetic coupling with the antenna. Specifically, dark regions indicate relatively low coupling with the antenna (high RF immunity), while light regions indicate relatively high coupling with the antenna (low RF immunity). It will be appreciated by anyone of ordinary skill in the art that the pattern represented in FIG. 6C does not offer great performance with respect to RF desensitization. Nearly half of the ground plane experiences undesirably high amounts of coupling with the antenna. Additionally, the pattern is highly varied and largely asymmetrical, making it even more difficult to intentionally shelter noisy components within the dark regions.

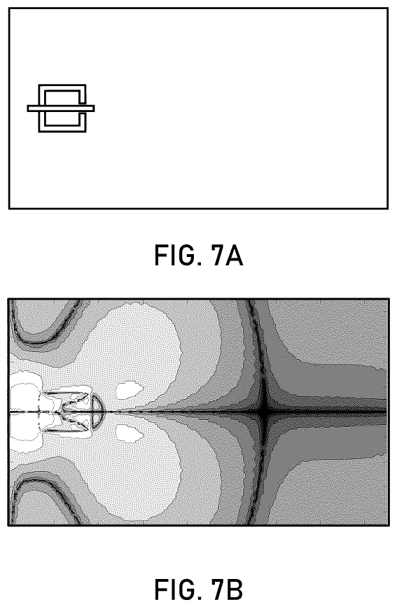

FIG. 7A is a graph of the antenna according to an embodiment. FIG. 7B is a graph illustrating the results of the computational technique for assessing performance in noise reduction described above when applied to the novel antenna. The differing shades correspond to differences in magnetic coupling with the antenna. Specifically, dark regions indicate relatively low coupling with the antenna (high RF immunity), while light regions indicate relatively high coupling with the antenna (low RF immunity). It will be appreciated by anyone of ordinary skill in the art that the pattern represented in FIG. 7B offers great performance with respect to RF desensitization. Of utmost importance is the portion of the ground plane contained within the dark regions. As can be readily observed, most of the ground plane is contained within dark regions, indicating that the RF desensitization experienced by this antenna is substantially less than that of other prior art antenna configurations. Such a large area of low coupling offers significant opportunities for engineers and manufacturers to incorporate noisy components preferentially into the low-coupling regions. Additionally, unlike the patterns of the Inverted-F antenna or patch antenna illustrated as shown in FIG. 6B and FIG. 6D, respectively, the pattern of the novel antenna shown in FIG. 7B is symmetrical about a horizontal axis, and offers a substantially uniform distribution about the ground plane. This makes it far easier to strategically incorporate noisy components into the shaded region.

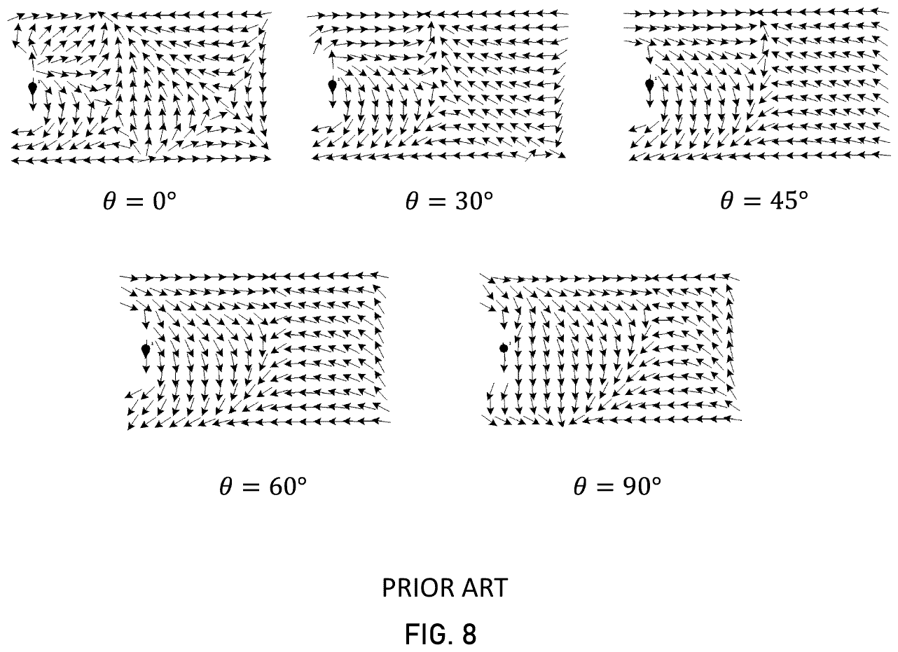

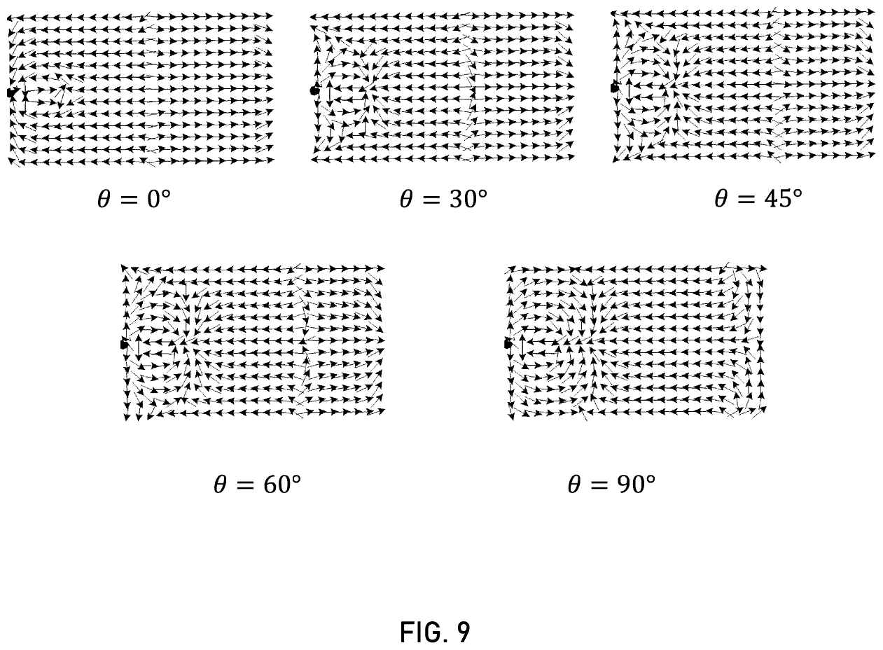

Referring now to FIG. 8 and FIG. 9, diagrammatic representations of current flow for an Inverted-F antenna and the novel antenna are shown, respectively. The lattice of arrows represents the direction of current along the ground plane at an instant in time associated with a phase angle represented by theta, shown below each of the number of snapshots over time. The phase angle in question is the phase of the alternating current supplied to the feed point of the metal trace. In the case of the Inverted-F antenna (FIG. 8), one can observe that as the phase angle progresses from zero degrees to ninety degrees, significant current rotation occurs along the ground plane. By current rotation it is meant that the current is not uniform, and moves in many directions at many different points along the ground plane at the same instant. This is a notable disadvantage with respect to noise-antenna coupling because it makes it functionally impossible to design circuitry in which most of the noise source current flows perpendicular to the antenna current. In the case of the novel antenna (FIG. 9), however, the antenna current flow is highly uniform and predictable, especially in the region farthest away from the antenna slot and metal trace. Excluding the region close to the antenna slot and metal trace, antenna current flow is almost entirely horizontal. That is, at any point on the ground plane and at any point in time, it is highly probably that the antenna current flow will be lateral (along the horizontal axis). With this configuration, it is not only possible, but quite easy to design a circuit with minimal coupling to the antenna. To do this, one need only preferentially orient the noisy components such that the current flowing through them is perpendicular to the antenna current flow.

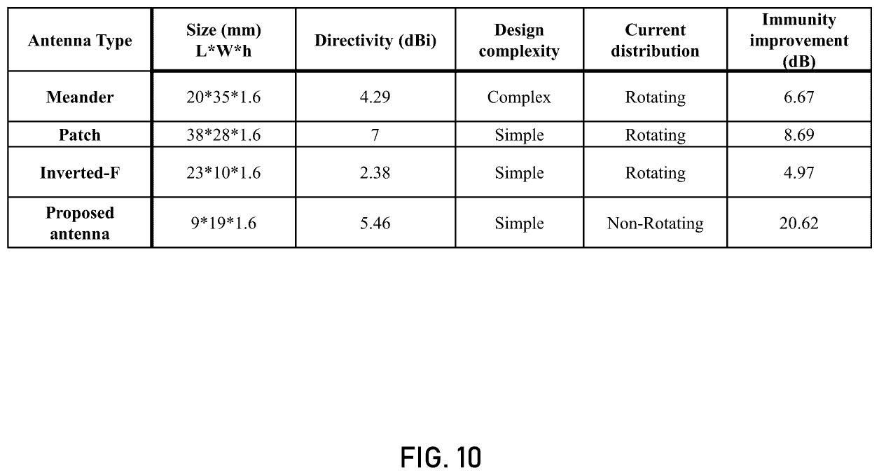

Referring now to FIG. 10, data is presented in the form of a chart which contains relevant information about performance for each of a number of antennas. Each row corresponds to a particular antenna type. The first three rows (excluding the header row) pertain to prior art antennas: meander antennas, patch antennas, and Inverted-F antennas. Each of these have been adapted and employed in wireless devices, so their performance is a meaningful indication of present technology. The final row contains information regarding the antenna of FIG. 1. The data presented in FIG. 10 was acquired via full-wave electromagnetic simulations.

Column 1 simply states the dimensions of the antenna. While there are variations in size which correlate to the geometry of each antenna configuration, the area of each of the antennas is similar. That is, each of the meander, patch, Inverted-F, and novel antenna may be reasonably implemented in a wireless device with the corresponding dimensions listed in column 1.

Column 2 indicates signal directivity. Directivity is a useful measure of an antennas radiation pattern and how power is emitted from the antenna at different angles. The unit for directivity used in this column is dBi, which represents the compared value of gain with respect to an isotropic antenna (i.e., an antenna with a uniform radiation pattern). The novel antenna's directivity of 5.46 dBi is within the standard range for wireless devices. The Meander antenna and Inverted-F antenna, for example, emit a less directed (i.e., more uniform) radiation pattern at 4.29 dBi and 2.38 dBi, respectively. The Patch antenna emits a more directed (i.e., less uniform) radiation pattern at 7 dBi. These data show that the novel antenna meets performance standards for widely adopted antennas with respect to directivity.

Column 3 states the design complexity of each antenna as a binary characteristic (either complex or simple), an easy factor to understand. Design complexity is determined by the geometry of the antenna design, and is strongly tied to the resources necessary to produce the antenna. The patch antenna, Inverted-F antenna, and the c-shaped antenna are all simple antennas. As such, they are easy and quick to manufacture. On the other hand, the Meander antenna has a complex design. Because of this, the Meander antenna is more difficult to manufacture. While design complexity is not inherently tied to performance, it certainly influences a manufacturer's ability to scale the antenna as a component in a product being sold in large numbers. From this column, one can see that the c-shaped antenna meets performance standards for widely adopted antennas with respect to design complexity.

Column 4 states the current distribution as a binary characteristic (either rotating or non-rotating). The c-shaped antenna is the only antenna with a non-rotating current distribution, a characteristic which can largely be credited for the antennas superior performance with respect to noise reduction. Because minimum coupling between the noise source and the antenna is achieved when the noise source current is orthogonal to the antenna current, it is favorable to have a non-rotating current distribution so that electronic components can be oriented such that their current distribution is in a fixed angular relationship with respect to the antenna's current distribution. This is not possible if the antenna emits a rotating current distribution, as the angular relationship between the rotating current and the noise source current is perpetually changing. Consequently, one can see that the c-shaped antenna exceeds performance standards for widely adopted antennas with respect to current rotation.

Column 4 shows immunity improvements for each of the antennas as the angular relationship between the noise source and the antenna is changed. To determine these improvements, simulated noise sources (e.g., small loop antennas) were placed according to the configuration shown in FIG. 5B. In this instance, the noise current flows along the horizontal axis. Noise coupling was recorded for each antenna. Then, the noise sources were rotated ninety degrees, such that the noise current flows along the horizontal axis. Noise coupling was again recorded for each antenna. The immunity improvements shown in Column 4 are the difference in coupling measurements between the two orientations of the noise sources. This is one way to represent current rotation about the ground plane: antennas with lots of current rotation will not experience a significant change in sensitivity as the noise source is rotated, while antennas with minimal current rotation will experience a significant change. From this, one can see that the novel antenna exceeds performance standards for widely adopted antennas with respect to noise immunity improvement as it pertains to changes in current distribution.

While the geometry of the novel slot antenna is a meaningful factor in its desirable performance, the slot itself is of upmost importance. Slot antennas have been neither adapted for nor used with compact devices, and have therefore remained unrecognized for their utility in this area. Additionally, because slot antennas have hitherto been relegated to non-compact technologies (e.g., marine radar systems, aircraft antennas, etc.), their performance characteristics with respect to RF desensitization have not been tested, as RF desensitization is an issue unique to compact devices. Consequently, one of ordinary skill in the art will readily appreciate the novelty of a slot antenna in a compact device, regardless of the antenna's geometry.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A slot antenna for use in a wireless device, comprising:
a conductive ground plane, the conductive ground plane defining a slot, the slot including a plurality of linear slot sections, the linear slot sections comprising;
a first slot section formed in the ground plane and extending outwardly from an interior point of the ground plane, having a proximal end and a distal end;
a second slot section formed in the ground plane perpendicular to the first slot section, the second slot section having a proximal end and a distal end, wherein the proximal end of the second slot section is connected to the distal end of the first slot section;
a third slot section formed in the ground plane parallel to the first slot section and perpendicular to the second slot section, the third slot section having a proximal end and a distal end, wherein the proximal end of the third slot section is connected to the distal end of the second slot section;
a fourth slot section formed in the ground plane parallel to the second slot section and perpendicular to the third slot section, the fourth slot section having a proximal end and a distal end, wherein the proximal end of the fourth slot section is connected to the distal end of the third slot section; and
a fifth slot section formed in the ground plane parallel to the third slot section and perpendicular to the fourth slot section, the fifth slot section having a proximal end and a distal end, wherein the proximal end of the fifth slot section is connected to the distal end of the fourth slot section; and
a metal trace on top of the ground plane and insulated therefrom, the metal trace extending horizontally across at least a portion of the slot and having a feed-point end and a termination end, wherein the metal trace is configured to supply excitation current to the slot antenna via the feed-point.

2. The slot antenna of claim 1, further comprising a substantially right angle slot junction where the linear slot sections meet each other.

3. The slot antenna of claim 1, wherein the fifth linear slot section is substantially aligned with the first linear slot section.

4. The slot antenna of claim 3, wherein:
the proximal end of the first linear slot section and the distal end of the fifth linear slot section are spaced apart across a portion of the ground plane, the portion defining a bridge; and
the metal trace extends across the bridge.

5. The slot antenna of claim 1, wherein:
each of the linear slot sections has a length; and
wherein the lengths of at least a pair of the linear slot sections is equal.

6. The slot antenna of claim 4, wherein:
the length of the first slot section and the length of the fifth slot section are equal; and
the lengths of the second, third, and fourth slot sections are equal.

7. The slot antenna of claim 1, wherein the ground plane has a substantially rectangular geometry.

8. The slot antenna of claim 7, wherein:
the substantially rectangular ground plane has two long edges and two short edges;
the second and fourth slot sections are parallel to the long edges; and
the first, third, and fifth slot sections are parallel to the short edges.

9. The slot antenna of claim 1, wherein the ground plane has two end regions and a center region, the slot being located at one of the end regions.

10. The slot antenna of claim 1, wherein each of the linear slot sections has a width, the widths of the slot sections being equal.

11. The slot antenna of claim 1, wherein the slot has a C-shape.

12. A slot antenna, comprising:
a conductive ground plane defining a slot, the slot including:
an inner perimeter and an outer perimeter, each of the inner perimeter and outer perimeter having a substantially rectangular geometry;
an inner region of the ground plane interior to the inner perimeter of the slot and an outer region of the ground plane exterior to the outer perimeter of the slot;
a bridge connecting the inner region to the outer region, the bridge having a first and second edge, the first edge and second edge being spaced apart a distance defining a bridge width; and
a metal trace on top of the ground plane and insulated therefrom, the metal trace extending horizontally across at least a portion of the slot and having a feed-point end and a termination end, wherein the metal trace is configured to supply excitation current to the slot antenna via the feed-point.

13. The slot antenna of claim 12, wherein the slot has a uniform width.

14. The slot antenna of claim 12, wherein the outer perimeter and the inner perimeter comprise nested square shapes, the square shapes each having an open side at the bridge.

15. The slot antenna of claim 12, wherein both the feed-point end and the termination end are located on the outer region of the ground plane.

16. The slot antenna of claim 12, wherein the ground plane has a substantially rectangular geometry.

17. The slot antenna of claim 12, wherein the metal trace extends across the bridge.

18. The slot antenna of claim 12, wherein the metal trace has a width, the width being less than the bridge width.

19. The slot antenna of claim 12, wherein the ground plane has two end regions and a center region, the slot being located at one of the end regions.

20. The slot antenna of claim 12, wherein the slot has a C-shape.
